(19) United States
(12) Patent Application Publication
(10) Pub. No.: US 2015/0320067 A1
(43) Pub. Date: Nov. 12, 2015

(54) LOW-FAT PROCESSED MOZZARELLA CHEESE AND FOOD ITEMS CONTAINING SAME

(71) Applicant: Jenny Lee Bryson, Johannesburg (ZA)

(72) Inventor: Jenny Lee Bryson, Johannesburg (ZA)

(21) Appl. No.: 14/118,528

(22) PCT Filed: May 19, 2011
(86) PCT No.: PCT/IB2011/001079

§ 371 Date: Feb. 13, 2014

(51) Int. Cl. A23C 19/068; A23C 19/082

(52) U.S. Cl. CPC A23C 19/0684; A23C 19/082

(57) ABSTRACT

The invention concerns a process for the production of a low-fat mozzarella comprising the steps of preparing a bulking pre-mix of dry components such as one or a mixture of rennet casein, sodium casein, milk protein concentrate and whey protein concentrate, salt, potassium sorbate and/or sorbic acid, sodium aluminium phosphate, sodium citrate, starch, skim milk powder, and stabiliser; adding said pre-mix to water at ambient temperature; raising the temperature to 80 to 85° C. whilst stirring the mixture; and adding natural mozzarella, sequestering agent, and citric acid monohydrate or lactic acid until the mixture is smooth and homogeneous.

### FIELD OF THE INVENTION

This invention relates to a low fat processed mozzarella cheese [sometimes also referred to as pasta filata cheese] and to its production. More particularly, the invention relates to a low-fat processed mozzarella cheese having a fat content that is below 10% of the dry matter present in the processed cheese [often referred to as a fat-free cheese in some in some regulatory areas].

The invention also relates to food items containing such a low-fat processed mozzarella cheese.

It is to be noted that a fat content of below 10% of the dry matter present in a cheese or processed cheese means that in many administrative regions, the product can be labelled as fat-free. Of course, the invention is not limited by this characteristic and can be varied to comply with administrative provisions applicable in other regions.

It is also to be noted that the term low fat processed mozzarella cheese as used in this specification has a natural mozzarella cheese content and includes what is sometimes referred to as low-fat processed imitation mozzarella cheese by virtue of the nature of any fat that may be added.

### BACKGROUND TO THE INVENTION

It is widely accepted that certain products that are referred to as fat-free have considerable appeal to weight and health conscious individuals who are often not prepared to eat products that are not labelled as “fat-free”.

The substantial milk fat content of natural cheese provides a soft body and texture with desirable melt characteristics. Substantial reduction of the fat content of natural cheese results in a more expensive cheese product with a relatively high percentage of protein. Without the effect of the fat, the processed cheese tends to be tough and rubbery in texture with poor melt characteristics.

Processed cheese is conventionally prepared by blending milk-fat containing cheeses and other dairy products such as whey solids and other milk protein isolates with emulsifying salts such as phosphates, for example disodium phosphate and citrates such as sodium citrate at elevated temperatures, typically 85 to 95° C., to produce a homogeneous cheese material which may be formed into sheets, slices or other forms, and packaged for consumer use. The substantial milk-fat content of processed cheeses not only provides a soft body and texture as well as desirable melt characteristics but also facilitates the processing of the natural cheese components at elevated temperatures in the manufacturing process. Elimination or even substantial reduction of the fat content of processed cheese may have a detrimental effect on the body, texture and melt characteristics of the resulting product as well as the processing of the cheese melt.

Nevertheless, consumer demand for low-fat foods that retain the quality of the corresponding full-fat formulation has led to the development of a large number of potential texturizing agents and fat replacers based on proteins, polyesters and a variety of other expedients.

Over many years, various attempts have been made to produce a processed mozzarella cheese that can be referred to as fat-free but, as far as applicant is aware, with a limited degree of success. As far as applicant is aware, these attempts have mostly been aimed at reducing the fat content during the mozzarella production process. On the other hand, synthetic mozzarella has also been produced.

It hardly needs to be mentioned that mozzarella cheese is regarded as a most important ingredient of extremely popular food items such as pizzas and certain pasta dishes.

### OBJECT OF THE INVENTION

It is an object of this invention to provide a low-fat processed mozzarella cheese, or processed mozzarella cheese product, that can termed, at least in some administrative regions, as “fat-free”, and a process for its production.

It is another object of the invention to provide a pizza that contains such a low-fat processed mozzarella cheese.

### SUMMARY OF THE INVENTION

In accordance with this invention there is provided a process for the production of a low-fat processed mozzarella cheese, the process comprising the steps of adding

a bulking pre-mix of dry components in the following amounts (expressed as percentages by weight of the final processed mozzarella cheese):

17 to 25% of any one or a mixture of rennet casein, sodium casein, milk protein concentrate and whey protein concentrate;

0.5 to 2% salt (sodium chloride or potassium chloride for reduced salt claim);

0.1 to 0.2% of potassium sorbate, sorbic acid or a mixture thereof;

0.2 to 0.6% sodium, aluminium phosphate or sodium hexa metaphosphate optionally containing a portion of sodium di phosphate;

1.5 to 3% sodium citrate being tri-sodium citrate (di- or penta-hydrate);

3 to 6% starch (potato starch);

5 to 10% skim milk powder that can contain partly whey powder; and

0.5 to 2% stabiliser selected from gelatine, carboxy methyl cellulose, carageenan, guar gum, locust bean gum and standardised with dextrose;

to water at ambient temperature with the water being present in a sufficient quantity to make up 100% after processing and including any condensate from steam that may be injected to elevate the temperature as specified;

raising the temperature to 80 to 85° C. and stirring the mixture until it is smooth and homogenous with good stretching properties;

thereafter adding;

12 to 18% natural mozzarella cheese together with

0.01 to 0.05% sequestering agent and

0% to 0.4% citric acid monohydrate or lactic acid (to balance the acidity);

and maintaining the temperature at 80 to 85° C. with mixing until the mixture is smooth and homogeneous.

Further features of the invention provide for the product low-fat mozzarella cheese to be filled into containers and subjected to medium fast cooling to about 25° C. followed by further cooling to a storage temperature at or below about 5° C.; for a suitable natural flavour to be added to the dry ingredients;

for a suitable natural colour to be added to the water; and for any citric acid or lactic acid to be added at approximately the same stage as that at which the natural mozzarella cheese is added to the prepared bulking pre-mix.

In instances in which steam is injected into the mixture in order to heat it, this steam will condense and add weight to the final processed mozzarella cheese thereby adding to the water added, as indicated above.

The natural mozzarella cheese may have a composition as follows:

| | |
|---|---|
| 45 to 55% | moisture; |
| 18 to 23% | fat; |
| 48 to 52% | fat in dry matter and |
| 0.5 to 1.5% | salt; |

and a pH of from 5.0 to 5.6.

The resultant low fat processed mozzarella cheese typically has a composition as follows:

| | |
|---|---|
| 41 to 46% | dry matter |
| 1 to 4% | fat |
| <10% | fat on a dry matter basis |
| pH | 6.00-6.40 |
| 1 to 2% | salt |
| 23 to 27% | protein, and, |
| 8 to 11% | carbohydrate (including lactose). |

In accordance with another aspect of the invention there is provided a low-fat pizza having a dough base, processed mozzarella cheese according to the invention, and a tomato mix, the pizza being characterized in that the processed mozzarella cheese is placed onto the pizza before the tomato mix is applied so that a processed mozzarella cheese layer is formed that is covered at least to a large extent by the tomato mix.

Further features of this aspect of the invention provide for the dough base to be made of a fat free dough that is precooked [but not baked in ‘oiled’ pans so that it remains substantially fat free]; for the tomato mix to be a simple tomato and spice mix that is also substantially fat-free; for any other ingredients to be applied either below or above a processed mozzarella cheese layer; and for the processed mozzarella cheese to be grated, shredded or crumbed prior to being applied to the pizza dough base.

This method of adding moist ingredients on top of the mozzarella cheese will ensure that the moisture within the cheese is maintained at an optimum moisture level and therefore offers a moist, stringy cheese that resists drying out.

It is to be noted that, as indicated above and in what follows, a percentage of water added as water is not the only water present in the final product as steam is used to heat the mixture to the temperatures stated by direct introduction of steam. The condensate from the steam thus adds to the overall water content of the product.

It should also be noted that different manufacturers may utilize steam in different ways to effect heating of the mixture and the steam pressure and dryness of the steam influences the heating time and the amount of condensate generated within the mixture. In some instances condensate will add up to about 12% whilst in other instances it may add up to as little as 5%.

Direct introduction of steam is considered the best option to heat products such as this due to its speed and efficiency as the time to reach a certain elevated temperature is a most import consideration. In the present application it is preferred heating take place in a time period of between about 5 and 8 minutes.

The time spent in a cooking pot after heating is also important and is normally managed by an operator and generally depends on the nature of the raw materials used, the rotation speed; the final temperature; as well as other considerations.

Of course, indirect steam heating may also be used in which instance no water condensate is added. However, some allowance may need to be made for vapour loss.

### DETAILED DESCRIPTION OF EXAMPLES OF THE INVENTION

In examples of the invention the natural mozzarella cheese was a standard mozzarella cheese produced from cows' milk, culture and rennet.

Alternatively, a milk acification process with citric acid or lactic acid can be used to produce natural mozzarella cheese.

### Example No 1

In one example 16.868% (expressed as a percentage by weight of the final processed mozzarella cheese) of natural mozzarella cheese was used in the recipe for the purpose of producing processed mozzarella cheese according to the invention.

The natural mozzarella cheese had the following analysis.

| | |
|---|---|
| Moisture | 50.4% |
| Fat | 21.2% |
| Fat in Dry matter | 42.74% |
| Salt | 1.05% |
| Acidity (pH) | 5.61 |

A bulking pre-mix of dry components was prepared with the following amounts of the individual components being expressed as percentages by weight of the final processed mozzarella cheese:

20.916% of any one or a mixture of rennet casein, sodium casein, milk protein concentrate and whey protein concentrate;

1.451% salt [sodium chloride or potassium chloride for reduced salt claim];

0.135% of potassium sorbate, sorbic acid or a mixture thereof;

0.337% of sodium aluminium phosphate or sodium hexa metaphosphate optionally containing a portion of sodium diphosphate;

2.463% sodium citrate being trisodium citrate di-hydrate or penta-hydrate;

4.723% potato starch;

6.747% skim milk powder [that can contain partly whey powder];

0.152% natural flavourant;

and

0.911% stabiliser selected from gelatine, carboxy methyl cellulose, carageenan, guar gum, locust bean gum and dextrose as well as suitable mixtures thereof.

The mixed components were added together with 0.004% natural colourant (annatto/turmeric blend) to water at ambient temperature of about 20° C. followed by raising the temperature to 85° C. with stirring at a speed of 120 RPM until the mixture was smooth and homogenous with good stretching properties. The amount of water was calculated to give a total weight of water of 35% including the condensate form the steam.

Thereafter there were added

16.868% natural mozzarella cheese as described above together with 0.034% sequestering agent in the form of liquid [polysorbate-60 or lecithin] and

0.236% citric acid monohydrate or lactic acid (to balance the acidity).

The temperature was maintained at 82° C. with stirring until the mixture was smooth and homogeneous.

It is to be noted that the percentages quoted based on the final processed mozzarella cheese do not add up to 100% and the balance is made up by the condensate from steam utilized in the process.

The product processed cheese was packaged into containers and subjected to medium fast cooling to about 25° C. followed by further cooling to a storage temperature at or below 5° C.

The product processed low fat mozzarella cheese had the following composition:

| | |
|---|---|
| 44.5% | dry matter |
| 3.86% | fat |
| 8.67% | fat on a dry matter basis |
| pH | 6.15 |
| 1.61% | salt |
| 25.27% | protein, and, |
| 9.94% | carbohydrate (including lactose). |

### Example No 2

In another example, 10.057% of natural mozzarella cheese for the purpose of producing processed mozzarella cheese according to the invention was used in the recipe. The mozzarella cheese had the following analysis.

| | |
|---|---|
| Moisture | 50.4% |
| Fat | 21.2% |
| Fat in Dry matter | 42.74% |
| Salt | 1.05% |
| Acidity (pH) | 5.61 |

A bulking pre-mix of dry components was prepared with the following amounts of the individual components being expressed as percentages by weight of the final processed mozzarella cheese:

22.541% of rennet casein, sodium casein, milk protein concentrate and whey protein concentrate;

1.451% salt [sodium chloride or potassium chloride for reduced salt claim];

0.139% of potassium sorbate, sorbic acid or a mixture thereof;

0.381% of sodium aluminium phosphate or sodium hexa metaphosphate optionally containing a portion of sodium di phosphate;

2.532% sodium citrate being trisodium citrate di-hydrate or penta-hydrate;

4.855% potato starch;

6.936% skim milk powder [that can contain partly whey powder];

0.156% natural flavourant;

and

0.936% stabiliser selected from gelatine, carboxy methyl cellulose, carageenan, guar gum, locust bean gum and dextrose and any suitable mixture thereof.

1.040% unsalted Butter to balance the loss of fat due to less cheese being used.

The mixed components were added together with 0.00414% natural colourant (annatto/turmeric blend) to water at ambient temperature of about 20° C. followed by raising the temperature to 85° C. with stirring at a speed of 120 RPM until the mixture was smooth and homogenous with good stretching properties. The amount of water was calculated to give a total weight of water of 36% including the condensate form the steam.

Thereafter there were added

10.057% natural mozzarella cheese together with

0.035% sequestering agent in the form of liquid polysorbate-60 or lecithin and

0.243% citric acid monohydrate or lactic acid (to balance the acidity).

The temperature was maintained at 82° C. with stirring until the mixture was smooth and homogeneous.

Once more, the balance of the weight of the processed cheese was made up of condensed steam.

The product processed cheese was packaged into containers and subjected to medium fast cooling to about 25° C. followed by further cooling to a storage temperature below about 5° C.

The product processed low fat mozzarella cheese had the following composition:

| | |
|---|---|
| 44.0% | dry matter |
| 3.3% | fat |
| 7.5% | fat on a dry matter basis |
| pH | 6.11 |
| 1.59% | salt |
| 25.66% | protein, and, |
| 10.10% | carbohydrate (including lactose). |

### Example No 3

In another example 24.958% of natural skim (fat free) mozzarella cheese was employed for the purpose of producing processed mozzarella cheese according to the invention. The natural mozzarella cheese had the following analysis.

| | |
|---|---|
| Moisture | 55.5% |
| Fat | 1.5% |
| Fat in Dry matter | 3.37% |
| Salt | 1.10% |
| Acidity (pH) | 5.23 |

A bulking pre-mix of dry components was prepared with the following amounts of the individual components being expressed as percentages by weight of the final processed mozzarella cheese:

14.262% of rennet casein, sodium casein, milk protein concentrate and whey protein concentrate or any suitable mixture thereof;

1.533 salt [sodium chloride or potassium chloride for reduced salt claim];

0.143% of potassium sorbate, sorbic acid or a mixture thereof;

0.535% of sodium aluminium phosphate or sodium hexa metaphosphate optionally containing a portion of sodium di phosphate;

2.603% sodium citrate being trisodium citrate di-hydrate or penta-hydrate;

3.922% potato starch;

7.131% skim milk powder [that can contain partly whey powder];

0.160% natural flavourant;

and

0.981% stabiliser selected from gelatine, carboxy methyl cellulose, carageenan, guar gum, locust bean gum and dextrose as well as any suitable mixture thereof.

3.565% unsalted butter was added to balance the loss of fat due to fat free cheese being used. This could be substituted with vegetable fat.

The mixed components were added together with 0.00426% natural colourant (annatto/turmeric blend) to water at ambient temperature at about 20° C. followed by raising the temperature to 85° C. with stirring at a speed of 120 RPM until the mixture was smooth and homogenous with good stretching properties. The amount of water was calculated to give a total weight of water of 29.237% including the condensate form the steam.

Thereafter there were added

24.958% natural mozzarella cheese as identified above together with 0.014% sequestering agent in the form of liquid polysorbate-60 or lecithin and

0.179% citric acid monohydrate or lactic acid (to balance the acidity).

The temperature was maintained at 82° C. with stirring until the mixture was smooth and homogeneous.

The product processed cheese was packaged into containers and subjected to medium fast cooling to about 25° C. followed by further cooling to a storage temperature below about 5° C.

The product processed low fat mozzarella cheese had the following composition:

| | |
|---|---|
| 44.0% | dry matter |
| 3.56% | fat |
| 8.09% | fat on a dry matter basis |
| pH | 6.07 |
| 1.81% | salt |
| 25.49% | protein, and, |
| 9.46% | carbohydrate (including lactose). |

### Example No 4

As regards the second aspect of the invention one example of a low-fat pizza having a dough base, processed mozzarella cheese according to the invention, and a tomato mix, is as follows.

The feature of note is that the processed mozzarella cheese is placed onto the pizza before the tomato mix is applied so that the tomato mix covers at least a large proportion of the processed mozzarella cheese.

The dough base is, in this instance, made of a fat free dough that may be made from 85 grams wheat flour; 85 grams of plain flour; grams of rice flour; ½ teaspoon salt; 14 gram dried yeast and 120 millilitres water. The dough sheets are precooked in non-oiled pans so that they remain substantially fat free.

The tomato/pizza sauce was made from 230 grams canned tomato paste; 610 grams of canned tomato sauce; 2 teaspoons freshly ground anise seeds; ¼ teaspoon pepper; ¼ teaspoon garlic powder; 1 teaspoon oregano; 1 teaspoon Italian seasoning; and 1 teaspoon chopped parsley.

Any other ingredients may be included either below or above the processed mozzarella cheese layer that is preferably used in a subdivided form such as grated, shredded or crumbed.

This method ensures that the moisture within the cheese is maintained at an optimum moisture level and therefore offers a moist, stringy cheese that does not dry out.

Numerous variations may be made to the examples of the invention given above without departing from the scope hereof.

1. A process for the production of a low-fat processed mozzarella cheese, the process comprising the steps of adding a bulking pre-mix of dry components in the following amounts (expressed as percentages by weight of the final processed mozzarella cheese):
17 to 25% of a component selected from any one or a mixture of rennet casein, sodium casein, milk protein concentrate, and whey protein concentrate;
0.5 to 2% salt selected from sodium chloride or potassium chloride;
0.1 to 0.2% of a component selected from potassium sorbate, sorbic acid and a mixture of potassium sorbate and sorbic acid;
0.2 to 0.6% a component selected from sodium aluminium phosphate and sodium hexa metaphosphate that may optionally contain a portion of sodium di phosphate;
1.5 to 3% sodium citrate being tri-sodium citrate;
3 to 6% starch;
5 to 10% skim milk powder that can contain partly whey powder; and
0.5 to 2% stabiliser selected from gelatine, carboxy methyl cellulose, carageenan, guar gum, locust bean gum and dextrose;
to water at ambient temperature with the water being present in a sufficient quantity to make up 100% after processing and including any condensate from steam that may be injected to elevate the temperature as specified;
raising the temperature to 80 to 85° C. and stirring the mixture until it is smooth and homogenous with good stretching properties;
thereafter adding;
12 to 18% natural mozzarella cheese together with
0.01 to 0.05% sequestering agent and
0% to 0.4% acid selected from citric acid monohydrate and or lactic acid;
and maintaining the temperature at 80 to 85° C. with mixing until the mixture is smooth and homogeneous.

2. A process as claimed in claim 1 in which the product low-fat mozzarella cheese is filled into containers and subjected to medium fast cooling to about 25° C. followed by further cooling to a storage temperature at or below about 5° C.

3. A process as claimed in claim 1 in which a suitable natural flavour is added to the dry ingredients.

4. A process as claimed in claim 1 in which a suitable natural colour is added to the water.

5. A process as claimed in claim 1 in which any citric acid or lactic acid is added at approximately the same stage as that at which the natural mozzarella cheese is added to the prepared bulking pre-mix.

6. A process as claimed in claim 1 in which in which heating is effected by injecting steam into the mixture and condensate forms part of the weight of water in the final processed mozzarella cheese.

7. A low fat processed mozzarella cheese whenever made by a process as claimed in claim 1.

8. A low-fat processed mozzarella cheese as claimed in claim 7 in which the processed mozzarella cheese has a composition as follows:

| | |
|---|---|
| 41 to 46% | dry matter |
| 1 to 4% | fat |
| <10% | fat on a dry matter basis |
| pH | 6.00-6.40 |
| 1 to 2% | salt |
| 23 to 27% | protein, and, |
| 8 to 11% | carbohydrate (including lactose). |

9-11. (canceled)
